(19) United States
(12) Patent Application Publication
(10) Pub. No.: US 2025/0192506 A1
(43) Pub. Date: Jun. 12, 2025

(54) LASER DEVICE AND LASER GENERATION METHOD

(71) Applicant: NATIONAL CHENG KUNG UNIVERSITY, Tainan City (TW)

(72) Inventors: Shu-Chun CHU, Tainan City (TW); Zheng Xian TSAI, Miaoli County (TW); Kuo-Chih CHANG, Tainan City (TW)

(21) Appl. No.: 18/434,834

(22) Filed: Feb. 7, 2024

(30) Foreign Application Priority Data
Dec. 11, 2023 (TW) 112148032

(51) Int. Cl. H01S 3/106; H01S 3/11

(52) U.S. Cl. CPC H01S 3/106; H01S 3/11

(57) ABSTRACT

A laser device includes an energy supply unit used to generate an initial light beam, a beam splitting unit, reflection units, an optical switch unit and an optical modulation unit. The beam splitting unit split the initial light beam into a first input light beam and a second input light beam. The reflection units are respectively disposed on propagation paths of the first input light beam and the second input light beam to form a first resonance cavity and a second resonance cavity, where the first resonance cavity and the second resonance cavity are respectively used to reflect the first input light beam and the second input light beam back and forth. The optical switch unit transforms the first input light beam into a pulsed laser. The optical modulation unit controls an output optical field of the first input light beam and the second input light beam.

### RELATED APPLICATIONS

This application claims priority to Taiwan Application Serial Number 112148032, filed Dec. 11, 2023, which is herein incorporated by reference in its entirety.

### BACKGROUND

### Field of Invention

The present disclosure relates to a laser device. More particularly, the present disclosure relates to a laser device including multiple resonance cavities.

### Description of Related Art

Currently, there are laser devices that incorporate an optical modulation element apiece into their resonance cavities to achieve direct modulation of the laser modes and real-time control. However, because common existing optical modulation elements, such as liquid crystal spatial optical modulators, have low damage thresholds, the laser power must decrease in order to allow the optical modulation element to operate within the tolerable power range, thereby limiting the output power of the laser device.

### SUMMARY

At least one embodiment of the present disclosure provides a laser device and a laser generation method, whereby the laser device can output pulsed laser or high power laser without destroying an optical modulation element by using multiple resonance cavities, and whereby the laser device can have the advantages of direct modulation of laser modes and real-time control due to the optical modulation element being disposed in the resonance cavity.

The laser device according to at least one embodiment of the present disclosure includes an energy supply unit, a beam splitting unit, reflection units, an optical switch unit and an optical modulation unit. The energy supply unit is used to generate an initial light beam. The beam splitting unit split the initial light beam into input light beams, where the input light beams include a first input light beam and a second input light beam. The reflection units are respectively disposed on propagation paths of the input light beams to form resonance cavities, where the propagation paths include a first propagation path of the first input light beam and a second propagation path of the second input light beam. The resonance cavities include a first resonance cavity and a second resonance cavity, where the first resonance cavity is disposed on the first propagation path of the first input light beam and is used to reflect the first input light beam back and forth, and the second resonance cavity is disposed on the second propagation path of the second input light beam and is used to reflect the second input light beam back and forth. The optical switch unit is disposed in the first resonance cavity and is disposed on the first propagation path of the first input light beam to transform the first input light beam into a pulsed laser. The optical modulation unit is disposed in the second resonance cavity and is disposed on the second propagation path of the second input light beam to control an output optical field of the second input light beam.

In some embodiments, the energy supply unit includes a gain unit, and one of the reflection units is disposed at the gain unit.

In some embodiments, the energy supply unit includes a gain unit, and the first resonance cavity and the second resonance cavity share the gain unit.

In some embodiments, one of the reflection units is disposed at the optical modulation unit.

In some embodiments, an output optical field of the first input light beam changes according to the output optical field of the second input light beam, and the second input light beam competes with the first input light beam for energy at the gain unit.

In some embodiments, the laser device further includes an energy control unit disposed on the propagation path of the input light beams to control an energy loss of the laser device.

In some embodiments, a laser threshold value of the second resonance cavity is lower than a laser threshold value of the first resonance cavity.

The laser device according to at least another embodiment of the present disclosure includes an energy supply unit, a pump, a gain unit, reflection units, an optical switch unit and an optical modulation unit. The energy supply unit is used to generate an initial light beam and includes a pump used to provide energy and a gain unit used to generate the initial light beam, where the initial light beam are split into a plurality of input light beams, and the input light beams include a first input light beam and a second input light beam. The reflection units are respectively disposed on propagation paths of the input light beams to form resonance cavities, where the propagation paths include a first propagation path of the first input light beam and a second propagation path of the second input light beam. The resonance cavities include a first resonance cavity and a second resonance cavity, where the first resonance cavity is disposed on the first propagation path of the first input light beam and used to reflect the first input light beam back and forth, and the second resonance cavity is disposed on the second propagation path of the second input light beam and used to reflect the second input light beam back and forth. The optical switch unit is disposed in the first resonance cavity and is disposed on the first propagation path of the first input light beam to transform the first input light beam into a pulsed laser. The optical modulation unit is disposed in the second resonance cavity and disposed on the second propagation path of the second input light beam to control an output optical field of the second input light beam.

In some embodiments, the first resonance cavity and the second resonance cavity share the gain unit.

The laser generation method according to at least one embodiment of the present disclosure includes the following steps. Disposing reflection units to form resonance cavities, where the resonance cavities include a first resonance cavity and a second resonance cavity. Making an energy supply unit generate an initial light beam. Using a beam splitting unit to split the initial light beam into input light beams, where the input light beams include a first input light beam and a second input light beam. Making the first input light beam be incident in the first resonance cavity, and then the first input light beam is reflected back and forth within the first resonance cavity. Making the second input light beam be incident in the second resonance cavity, and then the second input light beam is reflected back and forth within the second resonance cavity. Using an optical modulation unit to make the second resonance cavity generate a second output light beam. Making the first resonance cavity generate a first output light beam. Using an optical switch unit to transform the first output light beam into a pulsed laser. Using the optical modulation unit to simultaneously control output optical fields of the first output light beam and the second output light beam.

In some embodiments, the laser generation method further includes the following step. Changing the output optical field of the first output light beam according to the output optical field of the second output light beam.

### BRIEF DESCRIPTION OF THE DRAWINGS

FIG. 1 is a schematic diagram of a laser device according to at least one embodiment of the present disclosure.

FIG. 2 is a schematic diagram of a laser device according to at least another embodiment of the present disclosure.

FIG. 3 is a schematic diagram of a laser device according to at least another embodiment of the present disclosure.

FIG. 4A is a graph of the pulse laser signal versus time according to at least one embodiment of the present disclosure.

FIG. 4B is a graph of energy of pulsed laser versus input power according to at least one embodiment of the present disclosure.

FIG. 5 is a flowchart of a laser generation method according to at least one embodiment of the present disclosure.

### DETAILED DESCRIPTION

The embodiments of the present disclosure are discussed in detail below. It will be appreciated, however, that the embodiments provide many applicable concepts which may be implemented in a wide variety of specific contexts. The discussed and disclosed embodiments are for illustrative purposes only and are not intended to limit the scope of patent applications in this case.

It should be understood that while the present disclosure may use terms such as “first”, “second”, “third” to describe various elements or features, these elements or features should not be limited by these terms. These terms are primarily used to distinguish one element from another, or one feature from another.

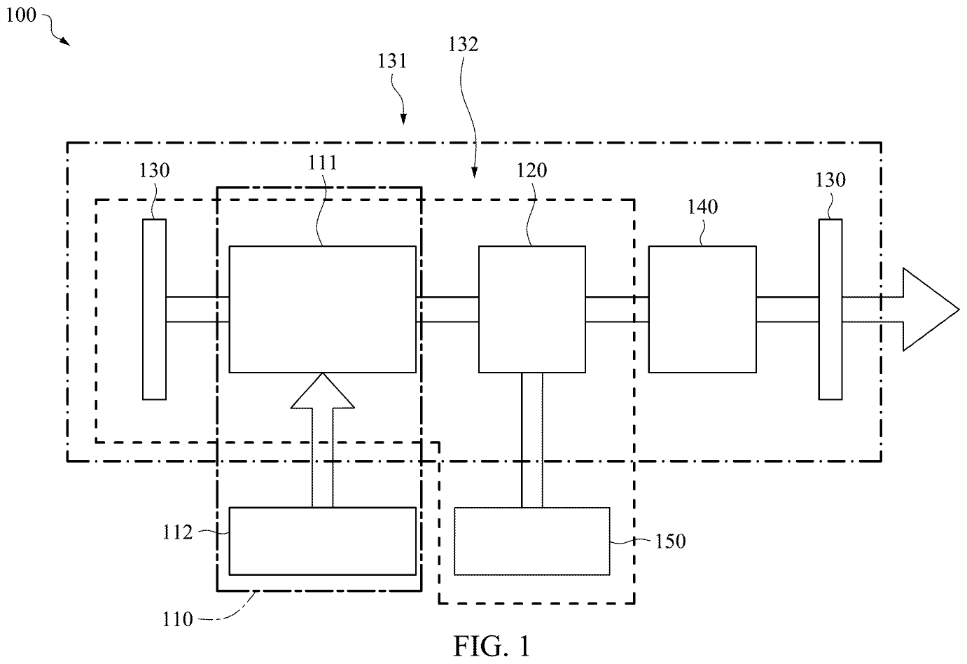

FIG. 1 is a schematic diagram of a laser device 100 according to at least one embodiment of the present disclosure. Referring to FIG. 1, the laser device 100 includes an energy supply unit 110, a beam splitting unit 120, reflection units 130, an optical switch unit 140, and an optical modulation unit 150. The energy supply unit 110 includes a gain unit 111 and a pump 112.

The pump 112 may be a device or a system that provides energy to the gain unit 111, such as an electric pump, an optical pump, a chemical energy pump, or a combination thereof. The electric pump may be a discharge tube, etc., and the optical pump may be a flash lamp, a light-emitting diode, etc. The gain unit 111 may accumulate the energy provided by the pump 112 so that the energy of light beams can be gain amplified in the gain unit 111 and the energy supply unit 110 generates an initial beam. The gain unit 111 is, for example, a Nd:YAG crystal, a He—Ne gas mixture, a diode, and the like. It should be noted that this should not limit the scope of the present disclosure.

The beam splitting unit 120 may split the initial light beam into input light beams, where the input light beams include a first input light beam and a second input light beam. The beam splitting unit 120 may be a partial reflector, a thin-film polarizer, a polarization beamsplitter, a Brewster Window, or a combination of a beamsplitter and a polarizer, or other element that allows the light beams to be separated or combined. It should be noted that this should not limit the scope of the present disclosure.

In the laser device 100, the reflection units 130 are respectively disposed on propagation paths of the input light beams. The reflection units 130 may be combinations of elements that allow the energy of the input light beams to be retained within the laser device 100, such as reflector mirrors, output couplers, dichroic beamsplitters, combinations of dichroic filters and reflector mirrors. It should be noted that this should not limit the scope of the present disclosure.

In addition, the reflection units 130 may form resonance cavities including a first resonance cavity 131 and a second resonance cavity 132. The first resonance cavity 131 is disposed on the propagation path of the first input light beam and is used to reflect the first input light beam back and forth, and the second resonance cavity 132 is disposed on the propagation path of the second input light beam and is used to reflect the second input light beam back and forth.

The optical switch unit 140 is disposed on the propagation path of the first input light beam. The optical switch unit 140 may be an element for blocking the first resonance cavity 131, or controlling the optical energy loss in the first resonance cavity 131, for example, the optical switch unit 140 may be a saturable absorber, chopper, acousto-optic modulator (AOM), or Pockels cell, or any combination of the above elements. The optical modulation unit 150 is disposed on the propagation path of the second input light beam. The optical modulation unit 150 may be an element that controls at least one of parameters, such as amplitude, phase, and polarization of the output optical field of the second input light beam. For example, the optical modulation unit 150 may be a liquid-crystal spatial light modulator (LC-SLM), a deformable mirror, or a digital micromirror device (DMD).

It should be noted that this should not limit the scope of the present disclosure. In addition, one of the reflection units 130 may be disposed at the optical modulation unit 150. For example, one of the reflection units 130 may be disposed in or on the optical modulation unit 150.

The laser device 100 is characterized by the first resonance cavity 131 and the second resonance cavity 132 formed by the reflection units 130, where the first resonance cavity 131 and the second resonance cavity 132 may share the gain unit 111, and the second resonance cavity 132 affects the number of carriers that the first resonance cavity 131 may obtain at the gain unit 111, so that the output optical field of the first resonance cavity 131 is affected by the output optical field of the second resonance cavity 132. That is, the second input light beam competes with the first input light beam for energy at the gain unit 111 so that the output optical field of the first input light beam can be changed by the second input light beam. In detail, the laser threshold value of the second resonance cavity 132 is lower than the laser threshold value of the first resonance cavity 131, for example, by 50%, so that the second resonance cavity 132 is prioritized to obtain carriers at the gain unit 111 and has priority to output the laser. It should be noted that this should not limit the scope of the present disclosure.

The control of the output optical field may be achieved by the optical modulation unit 150, the second resonance cavity 132 having the optical modulation unit 150 may select the area and range of gain obtained at the gain unit 111 by the optical modulation unit 150, and the first resonance cavity 131 not having the optical modulation unit 150 acquires carriers in the remaining gain range. The optical switch unit 140 may be incorporated in the first resonance cavity 131 without the optical modulation unit for use as a high power laser device or a pulse laser device. In this embodiment, the optical switch unit 140 may act as a Q-switch to transform the first output light beam into a pulsed laser. In other embodiments, the first resonance cavity 131 may not incorporate the optical switch unit 140 and may be used only as a high power laser device.

In other embodiments, the laser device 100 may be changed into a laser device with more than two resonance cavities by adding elements according to the above description, or the output light beam characteristics of the first input light beam may be changed by controlling the time characteristics of the second input light beam and changing the output conditions of the first input light beam in time.

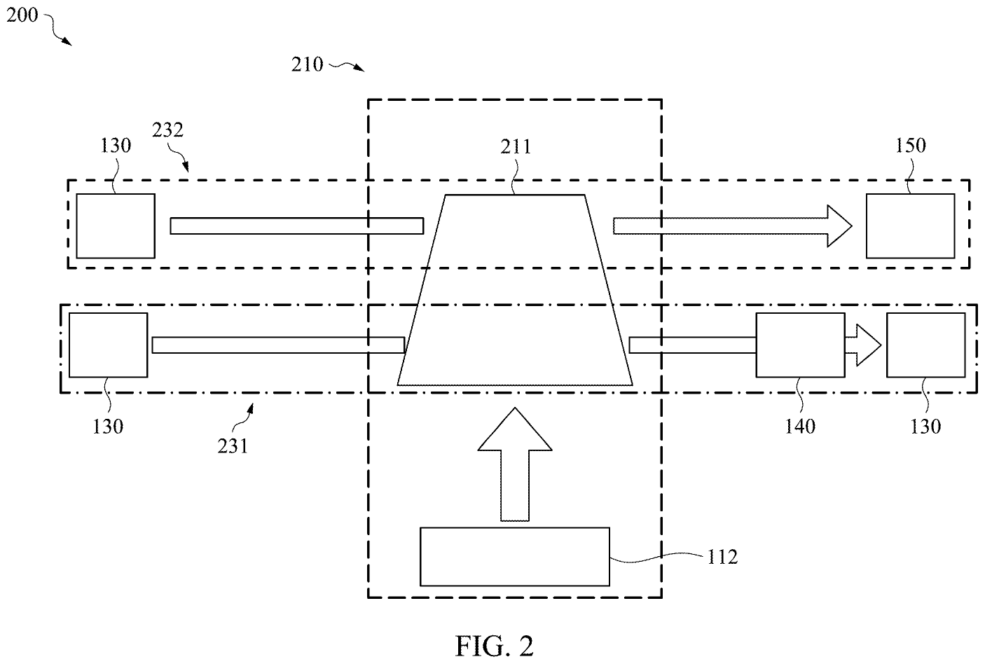

FIG. 2 is a schematic diagram of a laser device 200 according to at least another embodiment of the present disclosure. Referring to FIG. 2, the laser device 200 includes an energy supply unit 210, a reflection unit 130, an optical switch unit 140, and an optical modulation unit 150, wherein the energy supply unit 210 includes a gain unit 211 and a pump 112.

The pump 112 may be a device or a system that provides energy to the gain unit 211, such as an electric pump, an optical pump, a chemical energy pump, or a combination thereof. The electric pump may be a discharge tube, etc., and the optical pump may be a flash lamp, a light-emitting diode, etc. The gain unit 211 may accumulate the energy provided by the pump 112 so that the energy can be gain amplified in the gain unit 211 to generate an initial beam. The gain unit 211 is, for example, a Nd:YAG crystal, a He—Ne gas mixture, a diode, and the like. It should be noted that this should not limit the scope of the present disclosure.

In addition, in the laser device 200, the gain unit 211 may have polarization selectivity. In some embodiments, a polarization selection unit may be additionally added to the first resonance cavity 231 and the second resonance cavity 232.

In the laser device 200, the reflection units 130 are respectively disposed on propagation paths of the input light beams. The reflection units 130 may be combinations of elements that allow the energy of the input light beams to be retained within the laser device 200, such as reflector mirrors, output couplers, dichroic beamsplitters, combinations of dichroic filters and reflector mirrors. It should be noted that this should not limit the scope of the present disclosure.

The reflection units 130 may form resonance cavities including a first resonance cavity 231 and a second resonance cavity 232. The first resonance cavity 231 is disposed on the propagation path of the first input light beam and is used to reflect the first input light beam back and forth, and the second resonance cavity 232 is disposed on the propagation path of the second input light beam and is used to reflect the second input light beam back and forth.

The optical switch unit 140 is disposed on the propagation path of the first input light beam. The optical switch unit 140 may be an element for blocking the first resonance cavity 231, or controlling the optical energy loss in the first resonance cavity 231, for example, the optical switch unit 140 may be a saturable absorber, chopper, acousto-optic modulator (AOM), or Pockels cell, or any combination of the above elements. The optical modulation unit 150 is disposed on the propagation path of the second input light beam. The optical modulation unit 150 may be an element that controls at least one of parameters, such as amplitude, phase, and polarization of the output optical field of the second input light beam. For example, the optical modulation unit 150 may be a liquid-crystal spatial light modulator (LC-SLM), a deformable mirror, or a digital micromirror device (DMD).

It should be noted that this should not limit the scope of the present disclosure. In addition, one of the reflection units 130 may be disposed at the optical modulation unit 150. For example, one of the reflection units 130 may be disposed in or on the optical modulation unit 150.

The laser device 200 is characterized by the first resonance cavity 231 and the second resonance cavity 232 formed by the reflection units 130, where the first resonance cavity 231 and the second resonance cavity 232 may share the gain unit 211, and the second resonance cavity 232 affects the number of carriers that the first resonance cavity 231 may obtain at the gain unit 211, so that the output optical field of the first resonance cavity 231 is affected by the output optical field of the second resonance cavity 232. That is, the output optical field of the first input light beam may change according to the output optical field of the second input light beam, and the second input light beam competes with the first input light beam for energy at the gain unit. In detail, the laser threshold value of the second resonance cavity 232 is lower than the laser threshold value of the first resonance cavity 231, for example, by 50%, so that the second resonance cavity 232 is prioritized to obtain carriers at the gain unit 211 and has priority to output the laser. It should be noted that this should not limit the scope of the present disclosure.

The control of the output optical field may be achieved by the optical modulation unit 150, the second resonance cavity 232 having the optical modulation unit 150 may select the area and range of gain obtained at the gain unit 211 by the optical modulation unit 150, and the first resonance cavity 231 not having the optical modulation unit 150 acquires carriers in the remaining gain range. The optical switch unit 140 may be incorporated in the first resonance cavity 231 without the optical modulation unit for use as a high power laser device or a pulse laser device. In this embodiment, the optical switch unit 140 may act as a Q-switch to transform the first output light beam into a pulsed laser. In other embodiments, the first resonance cavity 231 may not incorporate the optical switch unit 140 and may be used only as a high power laser device. In addition, compared to the laser device 100 of FIG. 1, the laser device 200 only needs to be configured with the gain unit 211 to form a laser device with two input light beams, thus further saving the hardware configuration space.

In other embodiments, the laser device 200 may be changed into a laser device with more than two resonance cavities by adding elements according to the above description, or the output light beam characteristics of the first input light beam may be changed by controlling the time characteristics of the second input light beam and changing the output conditions of the first input light beam in time.

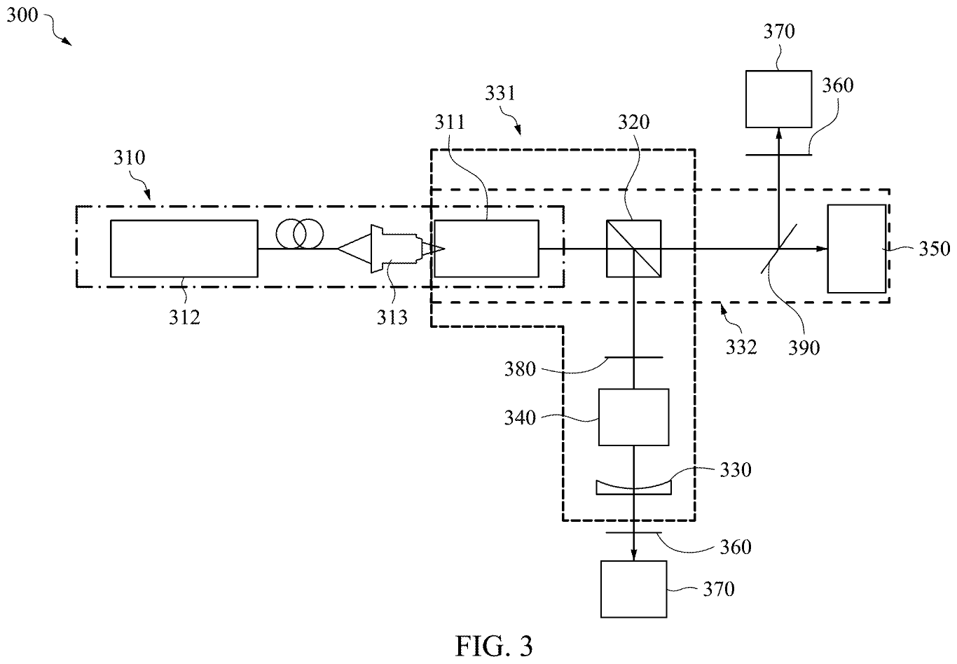

FIG. 3 is a schematic diagram of a laser device 300 according to at least another embodiment of the present disclosure. Referring to FIG. 3, the laser device 300 includes an energy supply unit 310, a beam splitting unit 320, a reflection unit 330, an optical switch unit 340, and an optical modulation unit 350. The energy supply unit 310 includes a gain unit 311, a pump 312.

The embodiment of the laser device 300 of FIG. 3 is similar to the laser device 100 of FIG. 1 and the laser device 200 of FIG. 2. The difference between embodiment of FIG. 3 and the embodiments of FIGS. 1-2 is that the energy supply unit 310 further includes a beam control unit 313, which controls the energy of the laser diode of the pump 312 and the spatial distribution in the gain unit 311. One of the reflection units 330 of the laser device 300 is disposed at the gain unit 311 of the energy supply unit 310. For example, one of the reflection units 330 of the laser device 300 is disposed in or on the gain unit 311 of the energy supply unit 310.

Two long pass filters 360 and two CCDs 370 are disposed on the propagation paths of the first input light beam and the second input light beam to observe the output optical fields of the first input light beam and the second input light beam, where a partial reflector 390 is disposed on the propagation path of the second input light beam to reflect the second input light beam to one of the CCDs 370. The long pass filters 360 pass only long wavelengths to the CCDs 370 and selectively block or reflect unwanted wavelengths.

As can be seen by the CCDs 370, in this embodiment, when the second input light beam is HG_{1,0} (not shown), the first input light beam generates HG_{0,1} (not shown), where HG_{m,n} are Hermite-Gaussian (HG) modes, and m, n are the mode number in the horizontal and vertical directions, respectively. When the output optical field of the second input light beam is varied by the optical modulation unit 350, the output optical field of the first input light beam is varied as well. It can thus be seen that the output optical field of the first input light beam of the laser device 300 changes with the second input light beam. Moreover, in the laser device 300, the optical switch unit 340 is an acousto-optic modulator, which can adjust the sparseness of the optical switch unit 340 to form a Q-switch, so that the first input light beam can be a pulsed laser. As can be seen from the above, the first input light beam can not only be controlled by the second input light beam to output an optical field, but also the first input light beam can be output as a pulsed laser.

Furthermore, the laser device 300 may include an energy control unit disposed on the propagation path of the input light beam to control the energy loss of the laser device 300. For example, the energy control unit may be a quarter-wave plate 380 disposed on the propagation path of the first input light beam to control the energy loss of the laser device 300.

It should be noted, however, that the above mentioned elements are not necessary and may be increased or decreased in accordance with functional requirements or other considerations. For example, in some embodiments, the laser device 300 may not incorporate the quarter-wave plate 380, and the same function may be achieved by adjusting the reflectivity of the reflection unit 330 to save hardware configuration space. Other details of this embodiment are similar to the above embodiments and will not be repeated herein.

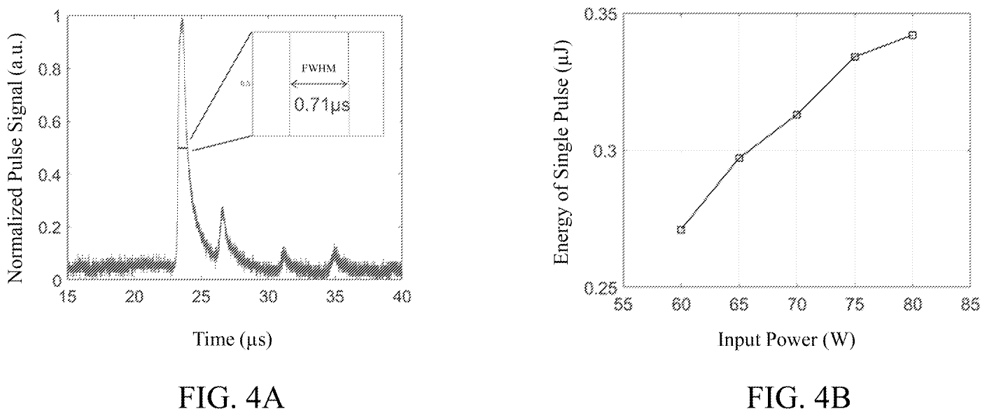

FIG. 4A is a graph of the pulse laser signal versus time according to the laser device 300 of FIG. 3. FIG. 4B is a graph of energy of pulsed laser versus input power according to the laser device 300 of FIG. 3. Referring to FIGS. 3, 4A, and 4B, it can be seen from the above description that the design of the two resonance cavities enables the laser device 300 to provide a high power laser beam in the first resonance cavity 331 or a pulsed laser in the first resonance cavity 331 by the optical switch unit 340 without decreasing the laser power and without destroying the optical modulation unit 350 in the resonance cavity. As can be seen, the laser device 300 has features such as high mode purity, high energy efficiency, high output power, and real-time control. As can be seen from FIGS. 4A and 4B, when the input power is 80 W, the output light beam of the laser device 300 can be pulsed laser, where the full width at half maximum (FWHM) of the pulsed laser is 0.71 μs.

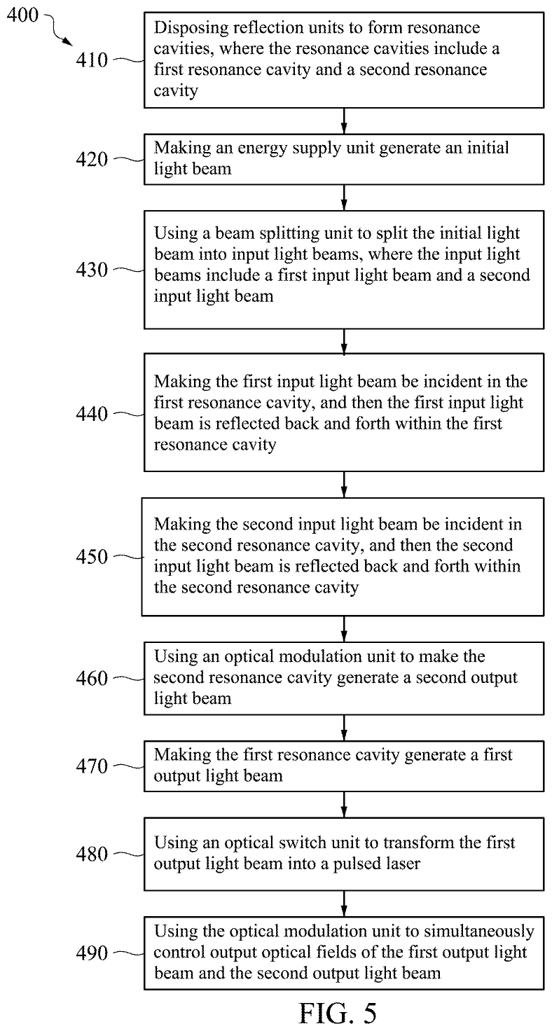

FIG. 5 is a flowchart of a laser generation method 400 according to at least one embodiment of the present disclosure. Referring to FIG. 5, the laser generation method 400 is applicable to the laser device 100 of FIG. 1, the laser device 200 of FIG. 2, and the laser device 300 of FIG. 3, or other similar laser devices.

The laser generation method 400 begins at step 410 with disposing reflection units to form resonance cavities, where the resonance cavities include a first resonance cavity and a second resonance cavity. The reflection unit may be the reflection unit 130 of FIG. 1, the reflection unit 130 of FIG. 2, the reflection unit 330 of FIG. 3 or other suitable reflection elements. The first resonance cavity may be the first resonance cavity 131 of FIG. 1, the first resonance cavity 231 of FIG. 2, the first resonance cavity 331 of FIG. 3. The second resonance cavity may be the second resonance cavity 132 of FIG. 1, the second resonance cavity 232 of FIG. 2, the second resonance cavity 332 of FIG. 3.

Step 420 is performed to make an energy supply unit to generate an initial beam. The energy supply unit may be the energy supply unit 110 of FIG. 1, the energy supply unit 210 of FIG. 2, the energy supply unit 310 of FIG. 3, or other suitable energy supply elements.

Next, step 430 is performed to use a beam splitting unit to split the initial light beam into input light beams, where the input light beams include a first input light beam and a second input light beam. The beam splitting unit may be the beam splitting unit 120 of FIG. 1, the gain unit 211 of FIG. 2, the beam splitting unit 320 of FIG. 3, or other suitable beam splitting elements.

Next, step 440 is performed to make the first input light beam be incident in the first resonance cavity, and then the first input light beam is reflected back and forth within the first resonance cavity. Step 450 is performed to make the second input light beam be incident in the second resonance cavity, and then the second input light beam is reflected back and forth within the second resonance cavity.

Next, step 460 is performed to use an optical modulation unit to make the second resonance cavity generate a second output light beam. The optical modulation unit may be the optical modulation unit 150 of FIG. 1, the optical modulation unit 150 of FIG. 2, the optical modulation unit 350 of FIG. 3, or other suitable light modulation elements.

Next, step 470 is performed to make the first resonance cavity generate a first output light beam. Step 480 is performed to use an optical switch unit to transform the first output light beam in to a pulsed laser. The optical switch unit may be the optical switch unit 140 of FIG. 1, the optical switch unit 140 of FIG. 2, the optical switch unit 340 of FIG. 3, or other suitable optical switch elements.

Thereafter, step 490 is performed to use the optical modulation unit to simultaneously control output optical fields of the first output light beam and the second output light beam.

It should be noted that the laser generation method 400 is applicable to the above-mentioned laser devices, but this should not limit the scope of the present disclosure. In other embodiments, variations can be made to apply to a laser device with multiple resonance cavities according to the illustrations of FIGS. 1, 2, and 3, and thus variations of embodiments derived from the laser generation method 400 are also within the scope of the present disclosure. In addition, in other embodiments, the steps of the laser generation method 400 may be added or changed in order based on functional requirements. For example, step 480 may be changed to be performed after step 490. Thus, step changes derived from the laser generation method 400 are also within the scope of the present disclosure.

As can be seen from the above embodiments, one of the advantages of the present disclosure is the resonance cavities formed by the reflection units. Moreover, the resonance cavities share the gain unit, and the resonance cavity with low laser threshold value can affect the resonance cavity with high laser threshold value, i.e., the carriers available at the gain unit, and make the output optical field of the input light beam of one of the resonance cavities change along with the output optical field of the input light beam of another of the resonance cavities, which can be controlled by the optical modulation unit and the optical switch unit, and make the output light beam be a pulsed laser.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A laser device, comprising:
an energy supply unit, used to generate an initial light beam;
a beam splitting unit, splitting the initial light beam into a plurality of input light beams, wherein the input light beams comprise a first input light beam and a second input light beam;
a plurality of reflection units, respectively disposed on a plurality of propagation paths of the input light beams to form a plurality of resonance cavities, wherein the propagation paths comprise a first propagation path of the first input light beam and a second propagation path of the second input light beam, and the resonance cavities comprise:
a first resonance cavity, disposed on the first propagation path of the first input light beam and used to reflect the first input light beam back and forth; and
a second resonance cavity, disposed on the second propagation path of the second input light beam and used to reflect the second input light beam back and forth;
an optical switch unit, disposed in the first resonance cavity and disposed on the first propagation path of the first input light beam to transform the first input light beam into a pulsed laser; and
an optical modulation unit, disposed in the second resonance cavity and disposed on the second propagation path of the second input light beam to control an output optical field of the second input light beam.

2. The laser device of claim 1, wherein the energy supply unit comprises a gain unit, and one of the reflection units is disposed at the gain unit.

3. The laser device of claim 1, wherein the energy supply unit comprises a gain unit, and the first resonance cavity and the second resonance cavity share the gain unit.

4. The laser device of claim 1, wherein one of the reflection units is disposed at the optical modulation unit.

5. The laser device of claim 1, wherein the energy supply unit comprises a gain unit, an output optical field of the first input light beam changes according to the output optical field of the second input light beam, and the second input light beam competes with the first input light beam for energy at the gain unit.

6. The laser device of claim 1, further comprising an energy control unit disposed on the propagation path of the input light beams to control an energy loss of the laser device.

7. The laser device of claim 1, wherein a laser threshold value of the second resonance cavity is lower than a laser threshold value of the first resonance cavity.

8. A laser device, comprising:
an energy supply unit, used to generate an initial light beam and comprising:
a pump, used to providing energy; and
a gain unit, used to generate the initial light beam, wherein the initial light beam are split into a plurality of input light beams, and the input light beams comprise a first input light beam and a second input light beam;
a plurality of reflection units, respectively disposed on a plurality of propagation paths of the input light beams to form a plurality of resonance cavities, wherein the propagation paths comprise a first propagation path of the first input light beam and a second propagation path of the second input light beam, and the resonance cavities comprise:
a first resonance cavity, disposed on the first propagation path of the first input light beam and used to reflect the first input light beam back and forth; and
a second resonance cavity, disposed on the second propagation path of the second input light beam and used to reflect the second input light beam back and forth;
an optical switch unit, disposed in the first resonance cavity and disposed on the first propagation path of the first input light beam to transform the first input light beam into a pulsed laser; and
an optical modulation unit, disposed in the second resonance cavity and disposed on the second propagation path of the second input light beam to control an output optical field of the second input light beam.

9. The laser device of claim 8, wherein the first resonance cavity and the second resonance cavity share the gain unit.

10. The laser device of claim 8, wherein one of the reflection units is disposed at the optical modulation unit.

11. The laser device of claim 8, wherein an output optical field of the first input light beam changes according to the output optical field of the second input light beam, and the second input light beam competes with the first input light beam for energy at the gain unit.

12. The laser device of claim 8, wherein a laser threshold value of the second resonance cavity is lower than a laser threshold value of the first resonance cavity.

13. A laser generation method, comprising:
disposing a plurality of reflection units to form a plurality of resonance cavities, wherein the resonance cavities comprise a first resonance cavity and a second resonance cavity;
making an energy supply unit generate an initial light beam;
using a beam splitting unit to split the initial light beam into a plurality of input light beams, wherein the input light beams comprise a first input light beam and a second input light beam;
making the first input light beam be incident in the first resonance cavity, and then the first input light beam is reflected back and forth within the first resonance cavity;
making the second input light beam be incident in the second resonance cavity, and then the second input light beam is reflected back and forth within the second resonance cavity;
using an optical modulation unit to make the second resonance cavity generate a second output light beam;
making the first resonance cavity generate a first output light beam;
using an optical switch unit to transform the first output light beam into a pulsed laser; and
using the optical modulation unit to simultaneously control output optical fields of the first output light beam and the second output light beam.

14. The laser generation method of claim 13, further comprising:
changing the output optical field of the first output light beam according to the output optical field of the second output light beam.
